(19) United States
(12) Patent Application Publication
(10) Pub. No.: US 2009/0177687 A1
(43) Pub. Date: Jul. 9, 2009

(54) METHOD FOR PROVIDING FLEXIBLE INHERITANCE OF PROGRAM ENVIRONMENT

(76) Inventor: Rune Ljungbjorn, Goteborg (SE)

Correspondence Address: Rune Ljungbjorn, Box 7068, Goteborg, 40232, SE

(21) Appl. No.: 12/349,530

(22) Filed: Jan. 7, 2009

Related U.S. Application Data
(60) Provisional application No. 61/019,943, filed on Jan. 9, 2008.

(51) Int. Cl. G06F 17/30

(52) U.S. Cl. 707/103 R; 707/E17.055

(57) ABSTRACT

The present invention relates to a method and a computer arrangement comprising a processor and a memory. The processor is operatively arranged to execute a group of instructions (program) present in the memory unit, so that said program can initiate execution of other programs, supplying said started programs with some data in memory in a standard format (environment), optionally used by said started programs and normally inherited by implicit copying or reference at further initiations of other programs. The invention provides extra inheritance paths for the environment data so that programs can be configured to inherit environment data from ancestor programs other than their immediate ancestors, overriding the environment of the immediate ancestors. This makes it possible to manage separately the behavior of application programs which start each other and would otherwise inherit the same environment. Selective inheritance is accomplished by ancestor processes putting specially formatted data into distinguished environment data objects (variables) and by arranging descendant programs to be started via starter programs, said starter programs interpreting said distinguished environment objects and making adjustments to the legacy environment data before starting the actual program (application).

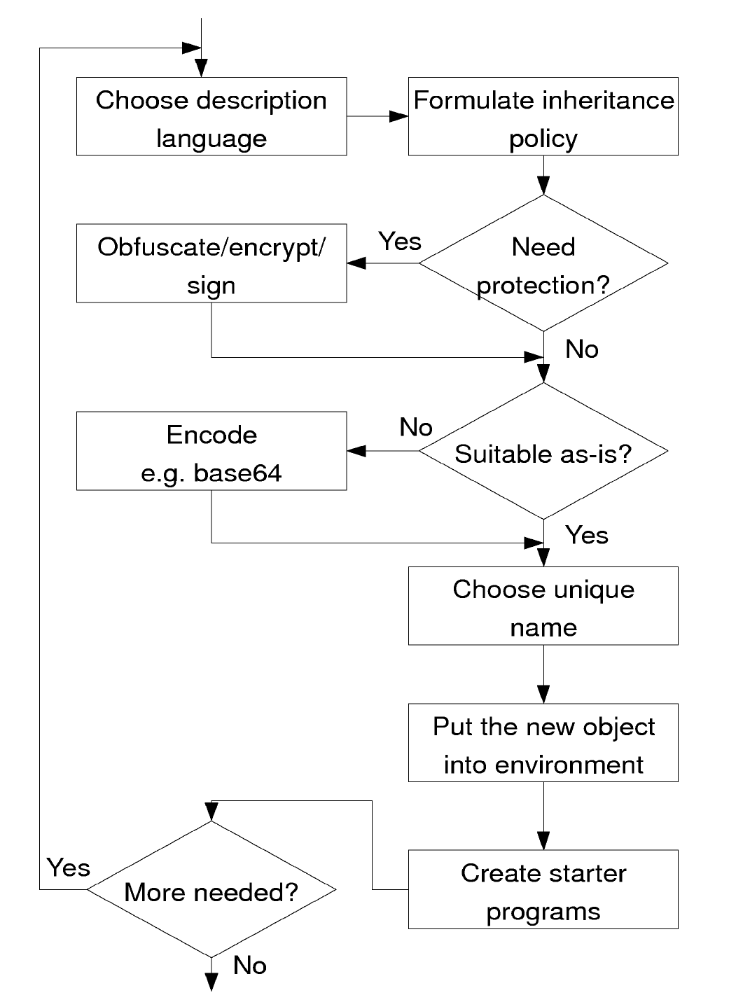

### THE TECHNICAL AREA OF THE INVENTION

The present invention relates to a method in a computer arrangement for configuration of a set of coded instructions for execution on computers or similar apparatus containing a processor and a memory unit, where collections of instructions (programs) may initiate execution of other programs in a standard way, passing along an inheritable block of data (environment), the said data being optionally used by the started program and/or passed on to further initiations of execution of programs. An example of such arrangement may be a computer running a Posix-compatible operating system.

### BACKGROUND OF THE INVENTION

Passing environment data to the initiated executing programs (processes) is a powerful means of management of process collections (process trees) as the environment data becomes available to the descendant processes without the need of any support from the intermediate descendants/ancestors. The behavior of processes in a whole process tree thus can be chosen by setting environment variables to certain values, according to how the application programs analyze the variables.

With this technique it is however impossible to manage collections of processes which do not represent trees. Another limitation is the fact that different application programs may use the same environment data in different incompatible ways. As an example, environment variable “EDITOR” is usually interpreted as a name of a preferred text editor. A certain text editor may be good for some applications (for manipulation of their internal data) but totally unsuitable for other ones.

This limitation can be worked around by running applications via starter programs which reset certain environment variables prior to the start of the actual application, but then the knowledge about the necessary specific configuration is usually hard-coded into the starter. This makes it impossible to change the environment-related configuration for the application without changing the starter.

### BRIEF SUMMARY OF THE INVENTION

The purpose of the present invention is to generalize environment configuration for applications by making provisions for multiple inheritance of environment data. The environment data contents to be used by an application program is dynamically modified by the dedicated application starter, while the controlling configuration data is supplied to the starter via the environment as well, via specially crafted environment data (variable or variables) not to be analyzed by the applications themselves. This allows an application starter to combine configuration settings possibly inherited from multiple different nodes in the process tree into derived values for environment variables actually analyzed by the corresponding application program to be started. Simple operations as context-sensitive set, reset, and concatenation of text strings are sufficient in practice for quite elaborated configuration, while arbitrarily complex algorithms for environment generation can be implemented if necessary.

### BRIEF DESCRIPTION OF THE DRAWING

The present invention will be described with reference to an accompanying drawing, representing a flow diagram over the method according to the invention.

### DETAILED DESCRIPTION OF THE INVENTION

The invention will be described with reference to a non-limiting embodiment, comprising setup of the target computer so that it runs a Posix-compatible operating system, supporting execve( ) system call or an equivalent, which passes environment data at initiation of a program run.

General steps to be taken are as follows:
1. An environment data description and manipulation language is chosen. As an example, Bourne Shell can be used, though a custom or a general purpose programming language capable of text string manipulation and a corresponding interpreter may be used instead as well.
2. Compile the description of an environment inheritance policy/algorithm. This involves formulation of the policy/algorithm in the language chosen in step 1 and optionally involves encryption of the resulting contents and/or adding a digital signature if protection from analysis and/or integrity protection are necessary. A variety of well known methods and tools is available for obfuscation, symmetric or asymmetric encryption and digital signing, like “pgp”.
3. If the data does not conform to specifications for environment data format or to expectations of legacy applications, then apply additional encoding to the resulting data of step 2. As a non-limiting example, base64 encoding can be used to make arbitrary data to conform to Posix standard for environment data.
4. Choose a unique dedicated environment variable name. To ensure that the chosen variable is not analyzed by the applications, its name is to be generated randomly, pseudo-randomly or in another way as appropriate to be unique. Such unique string can be used as a prefix or a suffix to a legacy variable name to distinguish the new name from the legacy one while preserving readability for humans.
5. Put the resulting data of step 3 into the environment variable chosen in step 4, in a system specific way, for example by configuration of the login application.
6. Provide each application of interest with a starter program which interprets the description found in the chosen dedicated variable, sets or modifies certain environment variables according to the description and then starts the application. If Bourne Shell is chosen as the description language, then the starter programs also can be easily implemented in Bourne Shell. There are also many general purpose programming languages and tools available for implementation of custom description languages and of the corresponding interpreting starter programs, e.g. “C” language with tools like “lex” and “yacc”. If the description is encrypted or otherwise encoded, a corresponding decryption and (if necessary) signature verification tool is to be used by the starter programs.
7. Repeat if necessary the steps 1 to 6 for additional inheritance policies and set up the starters to be affected by those policies to interpret the corresponding dedicated environment variables. A starter chain (when a starter program initiates another starter program) may be necessary if multiple inheritance policies are formulated by different means (e.g. in different environment manipulation languages and/or encodings).

A Non-Limiting Example:

Some hypothetical applications (to be referred as FIRST group) process texts in AAA programming language. They use the environment variable “EDITOR” to find and start a text editor. On a certain installation a best editor for that purpose would be the editor EXXX. Another group of applications (to be referred as SECOND group) processes texts in a language BBB. These applications also use the environment variable “EDITOR” to find and start a text editor. Manipulation of the texts in BBB language may be impossible with the editor EXXX but best done with the editor EYYY. Moreover, some users may prefer to use EYYY for AAA language texts as well, while yet another user population may prefer the editor EZZZ for the BBB language. Besides that, the users who explicitly set environment variable “EDITOR” may wish to get the same straightforward result as in legacy installations, which is to affect all applications.

The present invention makes it possible to provide the best solution for all groups of users in all these situations, for example by defining two additional application-class-specific inheritance paths, via variables EDITOR_AAA and EDITOR_BBB, in addition to EDITOR, as shown below. Bourne Shell notation is used throughout the example. The dedicated environment variable in this example is INHERIT_{—}7648876. Its contents is shown before the possible encryption and/or digital signing is applied. As a non-limiting example, programs referred to as encrypt_and_or_sign and decrypt_and_or_check_integrity may deploy well known techniques for data encryption, signing, decryption and verification as necessary. In this example encrypt_and_or_sign is supposed to output the result of the obfuscation or of the cryptographic transformation of its argument (or the argument itself if no transformation is necessary) to the standard output, while decrypt_and_or_check_integrity is supposed to decrypt the given file in place and return a non-zero exit status if the possible check fails.

Inheritance Policy Formulated in Bourne Shell, put into a Chosen Environment Variable:

```
INHERIT_7648876=“‘encrypt_and_or_sign ’
if [ “$APP_GROUP_7648876” = “FIRST” ]; then
  if [ -z “$EDITOR” ]; then
    if [ -z “$EDITOR_AAA” ]; then
        EDITOR=EXXX
    else
        EDITOR=“$EDITOR_AAA”
    fi
    export EDITOR
  fi
elif [ “$APP_GROUP_7648876” = “SECOND” ]; then
  if [ -z “$EDITOR” ]; then
    if [ -z “$EDITOR_BBB” ]; then
        EDITOR=EYYY
    else
        EDITOR=“$EDITOR_BBB”
    fi
    export EDITOR
  fi
fi“”
```

An Example Starter for an Application of the First Group:

#!/bin/sh
APP_GROUP_7648876=FIRST
echo “$INHERIT_7648876” >/tmp/tmp-inherit-$$
decrypt_and_or_check_integrity /tmp/tmp-inherit-$$ || exit 1
# interpret the policy:
./tmp/tmp-inherit-$$
rm /tmp/tmp-inherit-$$
# start the application with environment set according to the inheritance
rules:
exec applicationA.real “$@”
exit 1

An Example Starter for an Application of the Second Group:

#!/bin/sh
APP_GROUP_7648876=SECOND
echo “$INHERIT_7648876” >/tmp/tmp-inherit-$$
decrypt_and_or_check_integrity /tmp/tmp-inherit-$$ || exit 1
# interpret the policy:
./tmp/tmp-inherit-$$
rm tmp/tmp-inherit-$$
# start the application with environment set according to the inheritance
rules:
exec applicationB.real “$@”
exit 1

This means that the system administrator will be able to set proper defaults for both types of applications, while still allowing the users to override the choices, so that both inheritance from the initial (login) process and from the session's shells can be used in accordance to the system policies. Users will be able to use the environment variable EDITOR for backward compatibility or the newly introduced variables EDITOR_AAA and EDITOR_BBB to separately configure the two groups of applications. Note that a change of the policy would not postulate any changes in the starter programs unless the classification of the target applications into groups would be revised. Note also that the policy can be extended or overridden by a policy-aware dedicated program at any node in the process tree. Non-aware programs will not mistakenly influence the policy due to the name uniqueness ensured by step 4 above.

The present invention thus provides flexibility of formulation and implementation of environment configuration policies, using the standard environment inheritance and being compatible with the said inheritance, while providing the freedom of selectable paths and custom algorithms of inheritance between processes.

1. A method in a computer arrangement comprising a processor and a memory unit, said processor being operatively arranged to execute a group of instructions (program) present in the memory unit, so that said program can initiate execution of another program or programs, supplying at the said initiation time a structured data in a standard format (environment), optionally used by said started programs and normally inherited by implicit copying or reference at every further initiation of a program. The method is distinguished by a provision for selectable inheritance paths for the environment data by putting either direct or algorithmic descriptions of the desired environment objects and of their desired contents into one or more designated extra environment data objects (variables) and arranging the descendant programs to be started via dedicated starter programs, each starter program interpreting the data in said designated variables and making the corresponding adjustments to the legacy environment data before starting the actual program (application).

2. The method of claim 1, distinguished by said designated environment data objects being encoded to provide compatibility with specifications for environment data format and/or with legacy programs.

3. The method of claim 1, distinguished by said designated environment data objects being assigned names fully or partially composed of randomly generated strings of characters, to prevent name collisions with legacy variables.

4. The method of claim 1, distinguished by said designated environment data objects being encoded (obfuscated) to prevent or complicate possible analysis by third parties.

5. The method of claim 1, distinguished by said designated environment data objects being encrypted so that possession of the corresponding decryption keys is necessary to access the data.

6. The method of claim 1, distinguished by said designated environment data objects being cryptographically signed.
